(19) United States
(12) Patent Application Publication
(10) Pub. No.: US 2014/0212757 A1
(43) Pub. Date: Jul. 31, 2014

(54) NONAQUEOUS ELECTROLYTE SECONDARY BATTERY

(71) Applicants: Manabu Takijiri, Hyogo (JP); Masanobu Takeuchi, Hyogo (JP); Yoshinori Kida, Hyogo (JP)

(72) Inventors: Manabu Takijiri, Hyogo (JP); Masanobu Takeuchi, Hyogo (JP); Yoshinori Kida, Hyogo (JP)

(73) Assignee: SANYO ELECTRIC CO., LTD., Moriguchi-shi, Osaka (JP)

(21) Appl. No.: 14/240,255

(22) PCT Filed: Aug. 22, 2012
(86) PCT No.: PCT/JP2012/071155

§ 371 Date: Feb. 21, 2014

(30) Foreign Application Priority Data
Sep. 8, 2011 (JP) 2011-196371

(51) Int. Cl. H01M 4/505; H01M 4/525

(52) U.S. Cl. CPC H01M 4/505; H01M 4/525
USPC 429/223

(57) ABSTRACT

Provided is a nonaqueous electrolyte secondary battery having excellent output characteristics. A nonaqueous electrolyte secondary battery 1 includes a positive electrode 12, a negative electrode 11, a nonaqueous electrolyte, and a separator 13. The positive electrode 12 includes a positive electrode current collector, a positive electrode active material layer, and a carbon layer. The carbon layer is provided between the positive electrode current collector and the positive electrode active material layer. The positive electrode active material layer contains a lithium composite oxide. The lithium composite oxide has a molar ratio of nickel to manganese (nickel/manganese) of 6/4 or more.

### TECHNICAL FIELD

The present invention relates to a nonaqueous electrolyte secondary battery.

### BACKGROUND ART

Lithium composite oxides are extensively used as a positive electrode active material in nonaqueous electrolyte secondary batteries. For example, Patent Literature 1 discloses a secondary battery in which a cobalt-containing lithium composite oxide is used as a positive electrode active material.

### CITATION LIST

### Patent Document

Patent Document 1: Japanese Published Unexamined Patent Application No. 2007-48717

### SUMMARY OF INVENTION

### Technical Problem

In recent years, there has been a demand for development of a positive electrode active material having a low cobalt content. Known examples of the positive electrode active material having a low cobalt content include lithium composite oxides containing nickel and manganese, such as a lithium nickel manganese oxide.

However, in the nonaqueous electrolyte secondary battery in which such a lithium composite oxide is used as the positive electrode active material, sufficient output characteristics cannot be obtained, which is a problem.

It is a main object of the present invention to provide a nonaqueous electrolyte secondary battery having excellent output characteristics.

### Solution to Problem

A nonaqueous electrolyte secondary battery of the present invention includes a positive electrode, a negative electrode, a nonaqueous electrolyte, and a separator. The positive electrode includes a positive electrode current collector, a positive electrode active material layer, and a carbon layer. The carbon layer is provided between the positive electrode current collector and the positive electrode active material layer. The positive electrode active material layer contains a lithium composite oxide with a molar ratio of nickel to manganese (nickel/manganese) of 6/4 or more.

### Advantageous Effects of Invention

According to the present invention, it is possible to provide a nonaqueous electrolyte secondary battery having excellent output characteristics.

### BRIEF DESCRIPTION OF DRAWINGS

FIG. 1 is a schematic sectional view of a nonaqueous electrolyte secondary battery according to an embodiment of the present invention.

FIG. 2 is a schematic view of a three-electrode test cell in which each of positive electrodes fabricated in examples and comparative examples is used as a working electrode.

### DESCRIPTION OF EMBODIMENTS

A preferred embodiment of the present invention will be described below. However, the embodiment described below is merely an example. The present invention is not limited to the embodiment described below.

Furthermore, the drawings referenced in the embodiment and the like are schematically described. Therefore, the ratio of dimensions and the like of objects illustrated may be different from the ratio of dimensions and the like of actual objects. The ratio of dimensions and the like of objects may differ between the drawings in some cases. A specific ratio of dimensions and the like of objects should be determined by taking the following description into consideration.

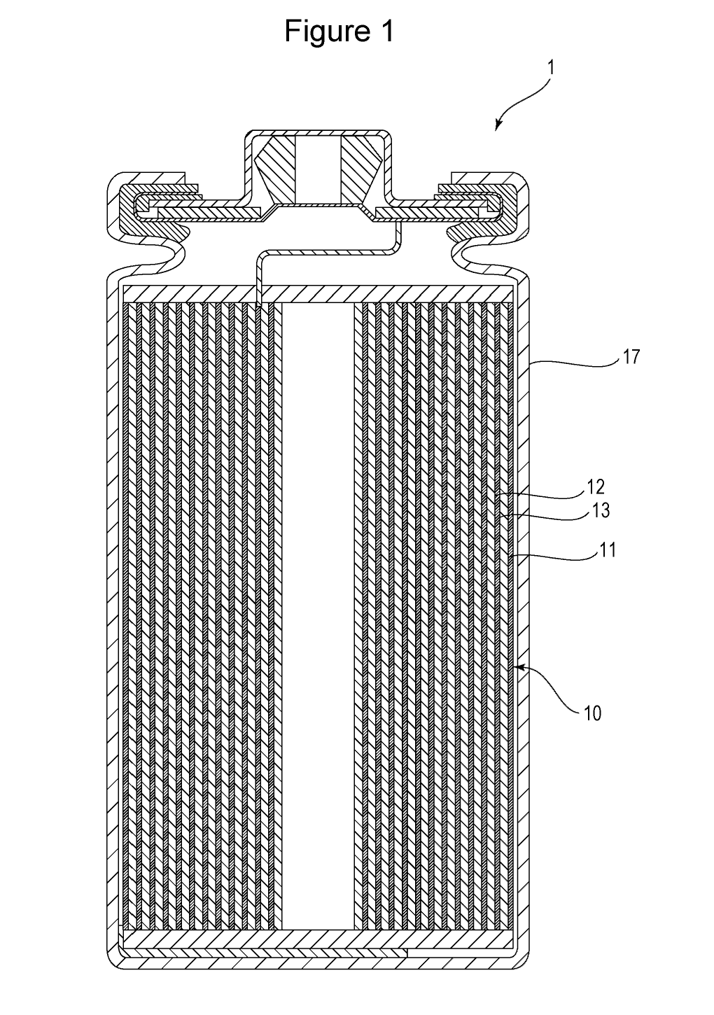

As shown in FIG. 1, a nonaqueous electrolyte secondary battery 1 includes a battery case 17. In this embodiment, the battery case 17 has a cylindrical shape. However, in the present invention, the shape of the battery case is not limited to the cylindrical shape. For example, the shape of battery case may be flat.

An electrode body 10 impregnated with a nonaqueous electrolyte is contained in the battery case 17.

As the nonaqueous electrolyte, for example, a known nonaqueous electrolyte can be used. The nonaqueous electrolyte contains a solute, a nonaqueous solvent, and the like.

As the solute of the nonaqueous electrolyte, for example, a known lithium salt can be used. Examples of the lithium salt that is preferably used as the solute of the nonaqueous electrolyte include a lithium salt containing at least one element selected from the group consisting of P, B, F, O, S, N, and Cl. Specific examples of such a lithium salt include LiPF₆, LiBF₄, LiCF₃SO₃, LiN(CF₃SO₂)₂, LiN(C₂F₅SO₂)₂, LiN(CF₃SO₂)(C₄F₉SO₂), LiC(C₂F₅SO₂)₃, LiAsF₆, LiClO₄, and the like. Among these, from the viewpoint of improving high-rate charge/discharge characteristics and durability, LiPF₆ is more preferably used as the solute of the nonaqueous electrolyte. The nonaqueous electrolyte may contain one solute or a plurality of solutes.

Examples of the nonaqueous solvent include a cyclic carbonate, a linear carbonate, and a mixed solvent of a cyclic carbonate and a linear carbonate. Specific examples of the cyclic carbonate include ethylene carbonate, propylene carbonate, butylene carbonate, and vinylene carbonate. Specific examples of the linear carbonate include dimethyl carbonate, methyl ethyl carbonate, and diethyl carbonate. In particular, a mixed solvent of a cyclic carbonate and a linear carbonate is preferably used as a nonaqueous solvent that has a low viscosity, a low melting point, and high lithium ion conductivity. In the mixed solvent of a cyclic carbonate and a linear carbonate, the mixing ratio of the cyclic carbonate to the linear carbonate (cyclic carbonate:linear carbonate), in terms of volume ratio, is preferably in the range of 2:8 to 5:5.

The nonaqueous solvent may be a mixed solvent of a cyclic carbonate and an ether solvent, such as 1,2-dimethoxyethane or 1,2-diethoxyethane.

Furthermore, as the nonaqueous solvent of the nonaqueous electrolyte, an ionic liquid can also be used. The cation species and the anion species of the ionic liquid are not particularly limited. From the viewpoint of low viscosity, electrochemical stability, and hydrophobicity, as the cation, for example, a pyridinium cation, an imidazolium cation, or a quaternary ammonium cation is preferably used. As the anion, for example, an ionic liquid containing, for example, a fluorine-containing imide-based anion is preferably used.

Furthermore, the nonaqueous electrolyte may be a gel-like polymer electrolyte in which a polymer electrolyte, such as polyethylene oxide or polyacrylonitrile, is impregnated with an electrolyte solution, or an inorganic solid electrolyte, such as LiI or Li₃N.

The electrode body 10 is formed by winding a negative electrode 11, a positive electrode 12, and a separator 13 disposed between the negative electrode 11 and the positive electrode 12.

The separator 13 is not particularly limited as long as it can suppress short-circuiting due to contact between the negative electrode 11 and the positive electrode 12, and can be impregnated with the nonaqueous electrolyte to obtain lithium ion conductivity. The separator 13 can be, for example, formed of a resin porous membrane. Specific examples of the resin porous membrane include a porous membrane made of polypropylene or polyethylene, and a laminated body of a porous membrane made of polypropylene and a porous membrane made of polyethylene.

The negative electrode 11 includes a negative electrode current collector and a negative electrode active material layer disposed at least one surface of the negative electrode current collector. The negative electrode current collector can be composed of, for example, a metal, such as copper, or an alloy containing a metal, such as copper.

The negative electrode active material is not particularly limited as long as it can reversibly occlude and release lithium. Examples of the negative electrode active material include a carbon material, a material that forms an alloy with lithium, and a metal oxide, such as tin oxide. Examples of the material that forms an alloy with lithium include at least one metal selected from the group consisting of silicon, germanium, tin, and aluminum, and an alloy containing at least one metal selected from the group consisting of silicon, germanium, tin, and aluminum. Specific examples of the carbon material include natural graphite, artificial graphite, mesophase-pitch based carbon fibers (MCF), mesocarbon microbeads (MCMB), coke, hard carbon, fullerene, and carbon nanotubes. From the viewpoint of improving high-rate charge/discharge characteristics, a carbon material in which a graphite material is coated with low-crystalline carbon is preferably used as the negative electrode active material.

The negative electrode active material layer may contain a known carbon conductive agent, such as graphite, a known binder, such as sodium carboxymethylcellulose (CMC) or styrene butadiene rubber (SBR), and the like.

The positive electrode 12 includes a positive electrode current collector, a positive electrode active material layer, and a carbon layer. The positive electrode current collector is preferably composed of aluminum or an aluminum alloy. Specifically, the positive electrode current collector is preferably formed of an aluminum foil or an alloy foil containing aluminum.

The carbon layer is provided on the surface of the positive electrode current collector. More specifically, the surface of the positive electrode current collector is covered with a layer of carbon. The positive electrode active material layer is provided on the surface thereof.

The positive electrode active material layer contains a positive electrode active material. The positive electrode active material layer may contain, in addition to the positive electrode active material, appropriate materials, such as a binder and a conductive agent. Specific examples of a binder that can be preferably used include polyvinylidene fluoride. Specific examples of a conductive agent that can be preferably used include carbon materials, such as graphite and acetylene black.

The positive electrode active material contains a lithium composite oxide with a molar ratio of nickel to manganese (nickel/manganese) of 6/4 or more. The positive electrode active material may be composed of only the lithium composite oxide with a molar ratio of nickel to manganese (nickel/manganese) of 6/4 or more, or may further contain another positive electrode active material other than the lithium composite oxide.

More preferably, the positive electrode active material contains a lithium composite oxide with a molar ratio of nickel to manganese (nickel/manganese) of 6/4 to 9/1. Furthermore, preferably, the lithium composite oxide contained in the positive electrode active material has a layered structure.

The lithium composite oxide may contain at least one selected from the group consisting of aluminum, titanium, chromium, vanadium, iron, copper, zinc, niobium, molybdenum, zirconium, tin, tungsten, sodium, and potassium in an amount of about 10 mole percent or less. The lithium composite oxide does not substantially contain cobalt, but may contain a very small amount of cobalt as an impurity.

As the lithium composite oxide, a lithium nickel manganese oxide is preferable, and a compound represented by the general formula: LiₐNiₓMn₁₋ₓO₂ (0.6≦x≦0.9, 1.03≦a≦1.2) is more preferable.

The positive electrode active material contains a water-soluble alkali component. Examples of the water-soluble alkali component include lithium hydroxide and lithium carbonate.

The amount of the water-soluble alkali component in the positive electrode active material is usually 0.15% by mass or more, and may be 0.20% by mass or more. The upper limit of the water-soluble alkali component in the positive electrode active material is about 1% by mass or less.

In the present invention, the amount of the water-soluble alkali component in the positive electrode active material is the value measured by a neutralization titration method (Warder method).

The carbon layer is provided between the positive electrode current collector and the positive electrode active material layer. Specifically, in this embodiment, the carbon layer is disposed so as to cover substantially the entire surface of the positive electrode current collector, and the positive electrode active material layer is disposed on the carbon layer. The carbon layer and the positive electrode active material layer may be provided only on one surface of the positive electrode current collector, or may be provided on both surfaces thereof.

The carbon layer contains a carbon material, a binder, and the like. Examples of the carbon material include furnace black, acetylene black, Ketjen black, graphite, and the like. The carbon layer may contain one carbon material or a plurality of carbon materials. Furthermore, examples of the binder include polyvinylidene fluoride, an acrylic resin, and the like. The carbon layer may contain one binder or a plurality of binders.

The positive electrode active material layer is generally formed by applying a slurry containing the positive electrode active material onto the surface of the positive electrode current collector. The slurry containing the positive electrode active material contains a solvent, such as water or N-methyl-2-pyrrolidone. The binder in the carbon layer may be swollen by the solvent in some cases. Furthermore, with the swelling of the binder in the carbon layer, there is a concern that the alkali component in the positive electrode active material may come into contact with the positive electrode current collector, resulting in corrosion of the positive electrode current collector. From the viewpoint of preventing these problems, the binder of the carbon layer is preferably an acrylic resin.

The amount of the binder contained in the carbon layer is preferably in a range of about 5% to 50% by mass. When the amount of the binder is in this range, adhesion between the carbon layer and the positive electrode current collector and between the carbon layer and the positive electrode active material layer can be enhanced. Furthermore, a space can be prevented from occurring between carbon materials in the carbon layer. Consequently, the surface of the positive electrode current collector can be effectively protected. If the amount of the binder in the carbon layer exceeds 50% by mass, the amount of the carbon material in the carbon layer becomes excessively small, which may result in a difficulty to secure a sufficient conductive property.

The thickness of the carbon layer is preferably about 10 μm or less, more preferably about 0.1 to 10 μm, and most preferably about 1 to 6 μm. When the thickness of the carbon layer is in this range, the carbon layer can be stably formed on the positive electrode current collector. Furthermore, the energy density of the nonaqueous electrolyte secondary battery can be improved.

As described above, as the positive electrode active material having a low cobalt content, lithium composite oxides containing nickel and manganese, such as a lithium nickel manganese oxide, are known. However, in the nonaqueous electrolyte secondary battery in which such a lithium composite oxide is used as the positive electrode active material, sufficient output characteristics cannot be obtained, which is a problem.

Furthermore, in general, in a lithium composite oxide containing nickel and manganese, among nickel and manganese, as the nickel content increases, the specific capacity of the nonaqueous electrolyte secondary battery increases, and the output characteristics increase. However, in the case where a lithium nickel manganese oxide having a low cobalt content, or the like, is used as the positive electrode active material, the output characteristics of the nonaqueous electrolyte secondary battery further decrease.

The causes of these problems are believed to be as follows. That is, a positive electrode of a nonaqueous electrolyte secondary battery is generally produced by applying a slurry, which is prepared by dispersing a positive electrode active material, a conductive agent, and a binder in a solvent, such as N-methyl-2-pyrrolidone or water, to the surface of a positive electrode current collector formed of a metal foil or the like.

As a result of thorough studies by the present inventors, it has become apparent that in the process of dispersing the positive electrode active material, such as a lithium nickel manganese oxide, in the solvent, water-soluble alkali components, such as lithium hydroxide and lithium carbonate, are generated, and a passivation film is formed by the water-soluble alkali components on the metal foil. The passivation film is believed to be one factor responsible for it not being possible to impart sufficient output characteristics to the nonaqueous electrolyte secondary battery using a positive electrode active material, such as a lithium nickel manganese oxide.

Furthermore, in a lithium nickel manganese oxide having a hexagonal layered structure, divalent nickel and trivalent nickel are present as a mixture, and tetravalent manganese is present. As the percentage of tetravalent manganese in the lithium nickel manganese oxide decreases, the percentage of trivalent nickel increases. Furthermore, in the atmosphere, trivalent nickel reacts with moisture in air and is easily reduced to divalent nickel. During that time, water-soluble alkali components, such as lithium hydroxide and lithium carbonate, are generated from the lithium nickel manganese oxide. Therefore, as the percentage of manganese decreases and the percentage of nickel increases in the lithium nickel manganese oxide, the amount of water-soluble alkali components in the positive electrode active material increases. Consequently, when the amount of water-soluble alkali components in the positive electrode active material increases, the thickness of the passivation film formed on the surface of the positive electrode current collector increases, and thus it is believed that the output characteristics of the nonaqueous electrolyte secondary battery are likely to be further degraded. Such a problem is noticeable in the case where a lithium composite oxide containing nickel and manganese with a low cobalt content is used as the positive electrode active material.

In contrast, in the nonaqueous electrolyte secondary battery 1, a carbon layer is provided between the positive electrode current collector and the positive electrode active material layer. The carbon material contained in the carbon layer has a conductive property and is stable against water-soluble alkali components. Consequently, by providing the carbon layer between the positive electrode current collector and the positive electrode active material layer, while suppressing an increase in the electrical resistivity between the positive electrode current collector and the positive electrode active material layer, it is possible to suppress formation of a passivation film on the surface of the positive electrode current collector due to water-soluble alkali components generated in the positive electrode active material layer. As a result, the output characteristics of the nonaqueous electrolyte secondary battery 1 can be improved.

In the nonaqueous electrolyte secondary battery 1, since the positive electrode active material layer contains a lithium composite oxide with a molar ratio of nickel to manganese (nickel/manganese) of 6/4 or more, the amount of nickel is larger than the amount of manganese in the positive electrode active material. Since the amount of nickel in the positive electrode active material is large, the output characteristics of the nonaqueous electrolyte secondary battery 1 can be improved. The amount of water-soluble alkali components contained in the positive electrode active material increases because a large amount of nickel is contained in the positive electrode active material. However, since the carbon layer is provided on the positive electrode current collector, it is possible to suppress formation of a passivation film on the surface of the positive electrode current collector.

The present invention will be described in further detail below on the basis of specific examples. However, it is to be understood that the present invention is not limited to the examples below, and various modifications may be appropriately made to the examples without departing the spirit and scope of the present invention.

### Example 1

Li₂CO₃ and Ni_{0.6}Nn_{0.4}(OH)₂ produced by a coprecipitation method were mixed at a predetermined ratio and fired in air at 1,000° C. for 10 hours. Thereby, a lithium nickel manganese oxide (Li_{1.1}Ni_{0.6}Mn_{0.4}O₂) having a layered structure was produced. This was used as a positive electrode active material.

Next, the amount of water-soluble alkali components in the resulting lithium nickel manganese oxide was measured by a neutralization titration method (Warder method). Specifically, 5 g of the lithium nickel manganese oxide was added to 50 ml of pure water, stirring was performed for one hour, and the solid content was removed by filtration to obtain an extract. An aqueous hydrochloric acid solution of known concentration was added dropwise to the extract until the PH was 8.4, and the dropped amount a of the aqueous hydrochloric acid solution was measured. The same aqueous hydrochloric acid solution was further added dropwise to the extract until the pH was 4.0, and the dropped amount β of the aqueous hydrochloric acid solution was measured. In the neutralization titration method, “2β” corresponds to the amount of lithium carbonate (Li₂CO₃) in the lithium nickel manganese oxide. Furthermore, “α−β” corresponds to the total amount of lithium hydroxide (LiOH) in the lithium nickel manganese oxide. The total sum of the amount of lithium carbonate and the amount of lithium hydroxide was defined as the amount of water-soluble alkali in the positive electrode active material. As a result of the measurement, the amount of water-soluble alkali in Li_{1.1}Ni_{0.6}Mn_{0.4}O₂ was 0.24% by mass.

Next, using a gravure coater, a slurry in which an acrylic resin and artificial graphite were dispersed was applied to both surfaces of a 15-μm aluminum foil such that the thickness for one surface was 2 μm to form carbon layers. In the slurry, the contents of the acrylic resin and the artificial graphite were 10 parts by mass and 90 parts by mass, respectively.

A slurry was prepared by mixing 94 parts by mass of the positive electrode active material, 4 parts by mass of artificial graphite serving as a carbon conductive agent, and 2 parts by mass of polyvinylidene fluoride serving as a binder, and further adding an appropriate amount of N-methyl-2-pyrrolidone (NMP) thereto. The resulting slurry was applied onto the carbon layer, followed by drying. This was cut into a predetermined electrode size and subjected to rolling using a roller. Then, a positive electrode lead was attached thereto to obtain a positive electrode.

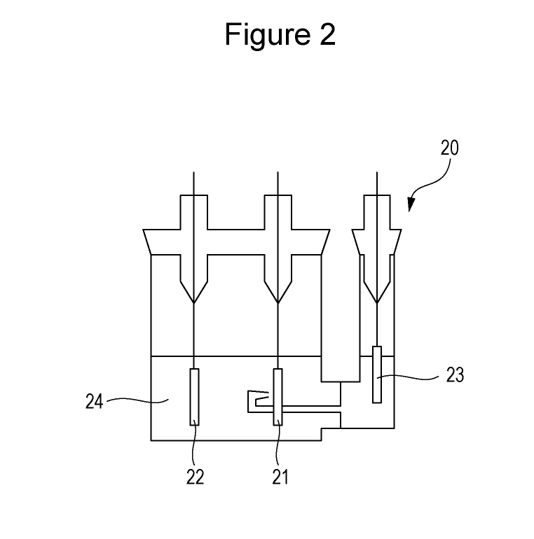

Next, using the positive electrode thus produced as a working electrode 21, a three-electrode test cell 20 shown in FIG. 2 was fabricated. As each of a counter electrode 22 serving as a negative electrode, and a reference electrode 23, metallic lithium was used. As a nonaqueous electrolyte 24, a solution was prepared by dissolving LiPF₆, with a concentration of 1 mol/L, in a mixed solvent in which ethylene carbonate, methyl ethyl carbonate, and dimethyl carbonate were mixed at a volume ratio of 3:3:4, and further dissolving 1% by mass of vinylene carbonate therein.

### Example 2

A three-electrode test cell 20 was fabricated as in Example 1 except that Li_{1.1}Ni_{0.7}Nn_{0.3}O₂ having a layered structure obtained by mixing Li₂CO₃ and Ni_{0.7}Mn_{0.3}(OH)₂ produced by a coprecipitation method at a predetermined ratio, followed by firing in air at 850° C. for 10 hours was used as a positive electrode active material. The amount of water-soluble alkali in Li_{1.1}Ni_{0.7}Nn_{0.3}O₂ was 0.44% by mass.

### Comparative Example 1

A three-electrode test cell 20 was fabricated as in Example 1 except that carbon layers were not provided on both surfaces of an aluminum foil.

### Comparative Example 2

A three-electrode test cell 20 was fabricated as in Example 2 except that carbon layers were not provided on both surfaces of an aluminum foil.

### Comparative Example 3

A three-electrode test cell 20 was fabricated as in Example 1 except that Li_{1.1}Ni_{0.5}Mn_{0.5}O₂ having a layered structure obtained by mixing Li₂CO₃ and a coprecipitated hydroxide represented by Ni_{0.5}Mn_{0.5}(OH)₂ produced by a coprecipitation method at a predetermined ratio, followed by firing in air at 850° C. for 10 hours was used as a positive electrode active material. The amount of water-soluble alkali in Li_{1.1}Ni_{0.5}Mn_{0.5}O₂ was 0.11% by mass.

### Comparative Example 4

A three-electrode test cell 20 was fabricated as in Comparative Example 3 except that carbon layers were not provided on both surfaces of an aluminum foil.

(Evaluation of Output Characteristics)

Using each of the three-electrode test cells 20 fabricated in Examples 1 and 2 and Comparative Examples 1 to 4, at a temperature of 25° C., at a current density of 0.2 mA/cm², constant current charging was performed until 4.5 V (vs. Li/Li+), constant voltage charging was performed at 4.5 V (vs. Li/Li+), and then constant current discharging was performed at a current density of 0.2 mA/cm² until 2.5 V (vs. Li/Li+). The discharge capacity at this time was defined as the rated capacity of each three-electrode test cell 20.

Subsequently, each of the three-electrode test cells 20 was charged up to 50% of the rated capacity, i.e., state of charge (SOC) 50%. Next, at −30° C., each three-electrode test cell 20 was discharged from the open-circuit voltage at 0.08 mA/cm², 0.4 mA/cm², 0.8 mA/cm², and 1.6 mA/cm², each for 10 seconds. The voltage 10 seconds after the discharge was plotted against each current, and a current-voltage line was obtained for each of the three-electrode test cells 20. From each current-voltage line, the current value Ip at an end-of-discharge voltage of 2.5 V was determined, and the output value at −30° C. was calculated from the equation below.

Output value=Ip×2.5

The results are shown in Tables 1 to 3. In Table 1, the output value of the three-electrode test cell 20 of Comparative Example 1 in which a carbon layer was not provided on the aluminum foil was defined as normalized value 100, and output characteristics were compared between Example 1 provided with the carbon layer and Comparative Example 1 not provided with a carbon layer. In the same manner, the normalized value of each of the three-electrode test cells 20 of Comparative Examples 2 and 4 in which a carbon layer was not provided on the aluminum foil was defined as 100, and output characteristics were compared between Example 2 provided with the carbon layer and Comparative Example 2 not provided with a carbon layer and between Comparative Example 3 provided with the carbon layer and Comparative Example 4 not provided with a carbon layer.

TABLE 1

| | | Amount of | | |
|---|---|---|---|---|
| | | water- | | Output |
| | Lithium nickel | soluble | | characteristics |
| | manganese | alkali | Carbon | (normalized |
| | oxide | (mass %) | layer | value) |
| Example 1 | Li_{1.1}Ni_{0.6}Mn_{0.4}O₂ | 0.24 | Provided | 112 |
| Comparative | Li_{1.1}Ni_{0.6}Mn_{0.4}O₂ | 0.24 | Not | 100 |
| Example 1 | | | provided | |

TABLE 2

| | | Amount of | | |
|---|---|---|---|---|
| | | water- | | Output |
| | Lithium nickel | soluble | | characteristics |
| | manganese | alkali | Carbon | (normalized |
| | oxide | (mass %) | layer | value) |
| Example 2 | Li_{1.1}Ni_{0.7}Mn_{0.3}O₂ | 0.44 | Provided | 127 |
| Comparative | Li_{1.1}Ni_{0.7}Mn_{0.3}O₂ | 0.44 | Not | 100 |
| Example 2 | | | provided | |

TABLE 3

| | | Amount | | |
|---|---|---|---|---|
| | | of water- | | Output |
| | Lithium nickel | soluble | | characteristics |
| | manganese | alkali | Carbon | (normalized |
| | oxide | (mass %) | layer | value) |
| Comparative | Li_{1.1}Ni_{0.5}Mn_{0.5}O₂ | 0.11 | Provided | 86 |
| Example 3 | | | | |
| Comparative | Li_{1.1}Ni_{0.5}Mn_{0.5}O₂ | 0.11 | Not | 100 |
| Example 4 | | | provided | |

As shown in Table 1, although Example 1 and Comparative Example 1 have the same composition of lithium nickel manganese oxide, the output characteristics of the three-electrode test cell 20 of Example 1 provided with the carbon layer are higher by 12 than those of Comparative Example 1 not provided with a carbon layer. Furthermore, although Example 2 and Comparative Example 2 have the same composition of lithium nickel manganese oxide, the output characteristics of the three-electrode test cell 20 of Example 2 provided with the carbon layer are higher by 27 than those of Comparative Example 2 not provided with a carbon layer.

On the other hand, when comparison is made between Comparative Example 3 and Comparative Example 4 which have the same composition and in which the nickel content in the lithium nickel manganese oxide is higher than that of each of Examples 1 and 2 and Comparative Examples 1 and 2, the output characteristics of the three-electrode test cell 20 of Comparative Example 3 provided with the carbon layer are lower by 14 than those of Comparative Example 4 not provided with a carbon layer. The results are believed to show that as the nickel content in the positive electrode active material decreases, the amount of alkali components contained in the positive electrode active material decreases, and the resistance-increasing effect of the carbon layer becomes larger than the positive electrode current collector-protecting effect of the carbon layer, resulting in a decrease in output characteristics.

### REFERENCE SIGNS LIST

1 nonaqueous electrolyte secondary battery
10 electrode body
11 negative electrode
12 positive electrode
13 separator
17 battery case
20 three-electrode test cell
21 working electrode
22 counter electrode
23 reference electrode
24 nonaqueous electrolyte

1. A nonaqueous electrolyte secondary battery comprising a positive electrode, a negative electrode, a nonaqueous electrolyte, and a separator,
wherein the positive electrode includes a positive electrode current collector, a positive electrode active material layer, and a carbon layer provided between the positive electrode current collector and the positive electrode active material layer; and
the positive electrode active material layer contains a lithium composite oxide with a molar ratio of nickel to manganese (nickel/manganese) of 6/4 or more.

2. The nonaqueous electrolyte secondary battery according to claim 1, wherein the amount of a water-soluble alkali component in the lithium composite oxide is 0.15% by mass or more.

3. The nonaqueous electrolyte secondary battery according to claim 1, wherein the lithium composite oxide is a compound represented by the general formula: LiₐNiₓMn₁₋ₓO₂ (0.6≦x≦0.9, 1.03≦a≦1.2).

4. The nonaqueous electrolyte secondary battery according to claim 1, wherein the positive electrode current collector contains aluminum.

5. The nonaqueous electrolyte secondary battery according to claim 1, wherein the thickness of the carbon layer is 10 μm or less.
